(19) United States
(12) Patent Application Publication
(10) Pub. No.: US 2007/0091417 A1
(43) Pub. Date: Apr. 26, 2007

(54) ELECTROPHORETIC MEDIA AND DISPLAYS WITH IMPROVED BINDER

(75) Inventors: Lan Cao, Arlington, MA (US); Elizabeth M. Gates, Somerville, MA (US); David D. Miller, Wakefield, MA (US); Guy M. Danner, Somerville, MA (US); Richard J. Paolini JR., Framingham, MA (US)

Correspondence Address: DAVID J COLE;E INK CORPORATION, 733 CONCORD AVE, CAMBRIDGE, MA, 02138-1002, US

(73) Assignee: E INK CORPORATION, Cambridge, MA (US)

(21) Appl. No.: 11/552,210

(22) Filed: Oct. 24, 2006

Related U.S. Application Data
(60) Provisional application No. 60/596,836, filed on Oct. 25, 2005.

(51) Int. Cl. G02B 26/00

(52) U.S. Cl. 359/296

(57) ABSTRACT

An electrophoretic medium comprises discrete droplets of an electrophoretic internal phase comprising a fluid and carbon black particles in the fluid. The droplets are surrounded by a polyurethane binder formed by a diisocyanate and a polyether diol, at least 20 mole per cent of the diisocyanate being an aromatic diisocyanate.

### REFERENCE TO RELATED APPLICATIONS

This application claims benefit of copending Application Ser. No. 60/596,836, filed Oct. 25, 2005.

This application is related to:
(a) U.S. Pat. No. 7,110,164;
(b) U.S. Pat. No. 6,982,178;
(c) U.S. Pat. No. 6,831,769; and
(d) U.S. Pat. No. 7,119,772.

The entire contents of this copending application and patents, and of all other U.S. patents and published and copending applications mentioned below, are herein incorporated by reference.

### BACKGROUND OF INVENTION

The present invention relates to electrophoretic media and displays with an improved binder. More specifically, this invention relates to electrophoretic media and displays with a binder which reduces dwell time dependence.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in published U.S. Patent Application No. 2002/0180687 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Particle-based electrophoretic displays have been the subject of intense research and development for a number of years. In this type of display, a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Patent Publication No. 2005/0001810; European Patent Applications 1,462,847; 1,482,354; 1,484,635; 1,500,971; 1,501,194; 1,536,271; 1,542,067; 1,577,702; 1,577,703; and 1,598,694; and International Applications WO 2004/090626; WO 2004/079442; and WO 2004/001498. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation have recently been published describing encapsulated electrophoretic media. Such encapsulated media comprise numerous small capsules, each of which itself comprises an internal phase containing electrophoretically-mobile particles suspended in a liquid suspending medium, and a capsule wall surrounding the internal phase. Typically, the capsules are themselves held within a polymeric binder to form a coherent layer positioned between two electrodes. Encapsulated media of this type are described, for example, in U.S. Pat. Nos. 5,930,026; 5,961,804; 6,017,584; 6,067,185; 6,118,426; 6,120,588; 6,120,839; 6,124,851; 6,130,773; 6,130,774; 6,172,798; 6,177,921; 6,232,950; 6,249,271; 6,252,564; 6,262,706; 6,262,833; 6,300,932; 6,312,304; 6,312,971; 6,323,989; 6,327,072; 6,376,828; 6,377,387; 6,392,785; 6,392,786; 6,413,790; 6,422,687; 6,445,374; 6,445,489; 6,459,418; 6,473,072; 6,480,182; 6,498,114; 6,504,524; 6,506,438; 6,512,354; 6,515,649; 6,518,949; 6,521,489; 6,531,997; 6,535,197; 6,538,801; 6,545,291; 6,580,545; 6,639,578; 6,652,075; 6,657,772; 6,664,944; 6,680,725; 6,683,333; 6,704,133; 6,710,540; 6,721,083; 6,724,519; 6,727,881; 6,738,050; 6,750,473; 6,753,999; 6,816,147; 6,819,471; 6,822,782; 6,825,068; 6,825,829; 6,825,970; 6,831,769; 6,839,158; 6,842,167; 6,842,279; 6,842,657; 6,864,875; 6,865,010; 6,866,760; 6,870,661; 6,900,851; 6,922,276; 6,950,200; 6,958,848; 6,967,640; 6,982,178; 6,987,603; 6,995,550; 7,002,728; 7,012,600; 7,012,735; 7,023,430; 7,030,412; 7,030,854; 7,034,783; 7,038,655; 7,061,663; 7,071,913; 7,075,502; 7,075,703; 7,079,305; 7,106,296; 7,109,968; 7,110,163; 7,110,164; 7,116,318; 7,116,466; 7,119,759; and 7,119,772; and U.S. Patent Applications Publication Nos. 2002/0060321; 2002/0090980; 2002/0180687; 2003/0011560; 2003/0102858; 2003/0151702; 2003/0222315; 2004/0014265; 2004/0075634; 2004/0094422; 2004/0105036; 2004/0112750; 2004/0119681; 2004/0136048; 2004/0155857; 2004/0180476; 2004/0190114; 2004/0196215; 2004/0226820; 2004/0239614; 2004/0257635; 2004/0263947; 2005/0000813; 2005/0007336; 2005/0012980; 2005/0017944; 2005/0018273; 2005/0024353; 2005/0062714; 2005/0067656; 2005/0078099; 2005/0099672; 2005/0122284; 2005/0122306; 2005/0122563; 2005/0122565; 2005/0134554; 2005/0146774; 2005/0151709; 2005/0152018; 2005/0152022; 2005/0156340; 2005/0168799; 2005/0179642; 2005/0190137; 2005/0212747; 2005/0213191; 2005/0219184; 2005/0253777; 2005/0270261; 2005/0280626; 2006/0007527; 2006/0024437; 2006/0038772; 2006/0139308; 2006/0139310; 2006/0139311; 2006/0176267; 2006/0181492; 2006/0181504; 2006/0194619; 2006/0197736; 2006/0197737; 2006/0197738; 2006/0198014; 2006/0202949; and 2006/0209388; and International Applications Publication Nos. WO 00/38000; WO 00/36560; WO 00/67110; and WO 01/07961; and European Patents Nos. 1,099,207 B1; and 1,145,072 B1.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the suspending fluid are not encapsulated within microcapsules but instead are retained within a plurality of cavities formed within a carrier medium, typically a polymeric film. See, for example, International Application Publication No. WO 02/01281, and published US Application No. 2002/0075556, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, the aforementioned U.S. Pat. Nos. 6,130,774 and 6,172,798, and U.S. Pat. Nos. 5,872,552; 6,144,361; 6,271,823; 6,225,971; and 6,184,856. Dielectrophoretic displays, which are similar to electrophoretic displays but rely upon variations in electric field strength, can operate in a similar mode; see U.S. Pat. No. 4,418,346.

An encapsulated electrophoretic display typically does not suffer from the clustering and settling failure mode of traditional electrophoretic devices and provides further advantages, such as the ability to print or coat the display on a wide variety of flexible and rigid substrates. (Use of the word “printing” is intended to include all forms of printing and coating, including, but without limitation: pre-metered coatings such as patch die coating, slot or extrusion coating, slide or cascade coating, curtain coating; roll coating such as knife over roll coating, forward and reverse roll coating; gravure coating; dip coating; spray coating; meniscus coating; spin coating; brush coating; air knife coating; silk screen printing processes; electrostatic printing processes; thermal printing processes; ink jet printing processes; and other similar techniques.) Thus, the resulting display can be flexible. Further, because the display medium can be printed (using a variety of methods), the display itself can be made inexpensively.

As already noted, an encapsulated electrophoretic medium typically comprises electrophoretic capsules disposed in a polymeric binder, which serves to form the discrete capsules into a coherent layer. The continuous phase in a polymer-dispersed electrophoretic medium, and the cell walls of a microcell medium serve similar functions. It has been found by E Ink researchers that the specific material used as the binder in an electrophoretic medium can affect the electro-optic properties of the medium. Among the electro-optic properties of an electrophoretic medium affected by the choice of binder is the so-called “dwell time dependence”. As discussed in the aforementioned U.S. Pat. No. 7,119,772 (see especially FIG. 34 and the related description). It has been found that, at least in some cases, the impulse necessary for a transition between two specific optical states of a bistable electrophoretic display varies with the residence time of a pixel in its initial optical state, and this phenomenon is referred to as “dwell time dependence” or “DTD”. Obviously, it is desirable to keep DTD as small as possible since DTD affects the difficulty of driving the display and may affect the quality of the image produced; for example, DTD may cause pixels which are supposed to form an area of uniform gray color to differ slightly from one another in gray level, and the human eye is very sensitive to such variations. Although it has been known that the choice of binder affects DTD, choosing an appropriate binder for any specific electrophoretic medium has hitherto been based on trial-and-error, with essentially no understanding of the relationship between DTD and the chemical nature of the binder.

It is known (see for example, copending application Ser. No. 11/428,584, filed Jul. 5, 2006) that various physico-chemical properties, especially the electrical properties, of the binder used in electrophoretic displays can have a significant effect on the electro-optic performance of such displays. Choosing a binder which satisfies all the relevant requirements for use in such displays is not easy, and in practice only a limited number of commercial materials are suitable. Typically, in practice a polyurethane resin, normally supplied as an aqueous latex, is used to form the binder. It has now been discovered that, for certain types of electrophoretic media, DTD is strongly influenced by the aromatic content of a polyurethane binder, and this invention provides electrophoretic media with polyurethane binders and low DTD.

### SUMMARY OF THE INVENTION

This invention provides an electrophoretic medium comprising a plurality of discrete droplets of an electrophoretic internal phase, the internal phase comprising a fluid and carbon black particles in the fluid, the droplets being surrounded by a polyurethane binder formed by a diisocyanate and a polyether diol, wherein at least about 20 mole per cent of the diisocyanate is an aromatic diisocyanate. Desirably at least about 50 mole per cent, and preferably at least about 75 mole per cent, of the diisocyanate is an aromatic diisocyanate. The internal phase used in the electrophoretic medium of the invention may comprise only carbon black particles in a colored fluid, but preferably the electrophoretic medium is of the dual particle type having a second type of electrophoretic particle (in addition to carbon black) in the fluid, the second type of electrophoretic particles differing from the carbon black particles in at least one optical characteristic, and in electrophoretic mobility. For example, in one preferred form of the present invention the electrophoretic medium contains carbon black particles and white titania particles bearing a charge of opposite polarity to the carbon black particles.

The polyurethane binder used in the display of the present invention may comprise a single polyurethane formed from an aromatic diisocyanate and a polyether diol. Alternatively, the binder used may comprise a blend of two or more polyurethanes, at least one of which is formed from an aromatic diisocyanate and a polyether diol. For example, the binder may comprise a first polyurethane formed from an aromatic diisocyanate and a polyether diol, and a second polyurethane formed from an aliphatic diisocyanate and a polyester diol. A preferred polyether diol for use in the polyurethane binder is poly(propylene glycol), desirably one having a molecular weight of about 1500 to about 5000.

The electrophoretic medium of the present invention may be an encapsulated electrophoretic medium having a capsule wall interposed between each droplet and the binder. The electrophoretic medium may also be of the polymer-dispersed type with the droplets of internal phase dispersed directly (without any intervening capsule wall) in a continuous phase of the binder. Finally, the electrophoretic medium of the present invention may be of the microcell type, with the binder forming the walls of a plurality of closed cavities within which the internal phase is retained.

This invention also provides an electrophoretic medium comprising a plurality of discrete droplets of an electrophoretic internal phase, the internal phase comprising a fluid and carbon black particles in the fluid, the droplets being surrounded by a polyurethane binder formed by a diisocyanate and a polyether diol, wherein at least about 20 mole per cent of the diisocyanate comprises TMXDI (see below for the formal name of this diisocyanate. In such a medium, at least about 50 mole per cent of the diisocyanate may comprises TMXDI; indeed, the diisocyanate may consist essentially of TMXDI.

This invention extends to an electrophoretic display comprising an electrophoretic medium of the invention in combination with at least one electrode disposed adjacent the electrophoretic medium and arranged to apply an electric field thereto.

### BRIEF DESCRIPTION OF THE DRAWINGS

FIG. 1 of the accompanying drawings is a graph showing the variation of dwell time dependence of the white state of a prior art electrophoretic binder against pulse length and rest period, as obtained in certain experiments described below.

FIG. 2 is a graph similar to FIG. 1 but showing the results obtained with a binder of the present invention, as described in Example 3 below.

FIGS. 3 to 5 are graphs similar to those of FIGS. 1 and 2 but showing the results obtained with a prior art binder, a simple binder of the present invention and a mixed binder of the present invention respectively.

FIGS. 6 to 8 are graphs similar to those of FIGS. 3 to 5 respectively but showing the corresponding dark state dwell time dependencies.

### DETAILED DESCRIPTION

As already mentioned, the present invention relates to an electrophoretic medium comprising carbon black electrophoretic particles and a polyurethane binder. At least part of the binder is formed from an aromatic diisocyanate and a polyether diol. It should be noted that the present invention appears to be specific to electrophoretic media containing carbon black (although similar results may be obtained from electrophoretic media containing other electrically-conductive electrophoretic particles, for example metals); similar results are not obtained from electrophoretic media in which the carbon black is replaced by a non-conductive particle, for example copper chromite.

As discussed in several of the aforementioned E Ink and MIT patents and published applications (see especially U.S. Pat. No. 7,012,600) in order to achieve accurate gray levels in an electrophoretic display, it is necessary that the correct impulse (the integral of voltage with respect to time) be delivered to a pixel to place the electrophoretic particles in the correct positions to generate the desired optical state. In electrophoretic displays where the internal phase (electrophoretic particles and surrounding fluid) is in direct contact with the electrodes, this is simple. However, in encapsulated media (whether of the capsule-based, polymer-dispersed or microcell types), there is an ionic conducting polymeric external phase (capsule wall and/or binder) in between the internal phase and the electrodes, and hence a complex charge screening layer is formed that can affect the field actually experienced by the electrophoretic particles. Moreover, the charge screening layer will decay over time after the applied voltage has been removed. This residual charge screening layer adds a real voltage to subsequent addressing pulses that will vary the electric field experienced by the electrophoretic particles, hence delivering an incorrect impulse to the electrophoretic particles. The macroscopic effect of this inadvertent “distortion” of the applied electric field is that a spatially correlated afterimage can appear in a subsequent image updates, and the severity of this afterimage correlates to the time since the last image update.

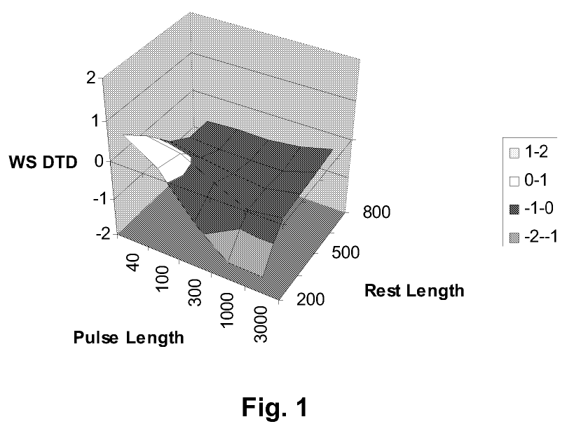

It has been discovered that the major factor affecting the amount of DTD seen in an electrophoretic display is the type of binder used. It is known (see for example the aforementioned U.S. Pat. No. 6,831,769) that a blend of two latex polyurethanes can be used as a binder in an encapsulated electrophoretic medium. The DTD of such a medium can be measured by observing a reference optical state (for a given pulse length) when the sample is switched after resting for a long period (say 30 seconds) with in its previous optical state. This reference state is compared to the optical state obtained when a shorter rest period (typically 0.4 to 10 second) is used. In order to allow for the effects of electrophoretic medium switching speed and medium thickness, this DTD measurement is repeated for multiple pulse lengths and the results are plotted as a three dimensional graph of optical difference against pulse length and rest period. FIG. 1 of the accompanying drawing shows such a graph of the white state DTD for a laboratory scale sample using a conventional mixed polyurethane latex binder. It will be appreciated that DTD can be different for white-to-black and black-to-white transitions; “white state DTD” refers to the effect of a final white state of varying rest periods in a previous black or gray state.)

The absolute values in the graph depend on the reference state, and thus are less important than the full range of optical states resulting from changes in rest period and pulse length. Accordingly, the most convenient parameter to characterize DTD is Maximum-Minimum range of these measurements, which in FIG. 1 is 2.4 L* units. Another important characteristic is the shape of the curve: in FIG. 1, the maximum DTD occurs at short pulse lengths and short rest periods, and the effect of DTD is to increase the optical state for the white state. This implies that the electrophoretic particles are experiencing a larger voltage when switched under these conditions.

The effects of changes in the binder composition are illustrated in the Examples below.

It is now necessary to consider the effect of polyurethane chemistry in the present invention. As is well known to those skilled in polyurethane technology, a diisocyanate is a compound containing two —N═C═O (NCO) groups. A urethane linkage is formed when an isocyanate group reacts with a hydroxyl group. The polyaddition reaction between a diisocyanate and a diol (a compound containing two hydroxyl groups) is the basic reaction to produce a polyurethane. Because some isocyanates react with water, only less reactive aliphatic diisocyanates are commonly used in the synthesis of water-borne polyurethane dispersions (latices); however, tetramethylxylene diisocyanate (TMXDI-IUPAC name 1,3-bis(1-isocyanato-1-methylethyl)benzene) can be used for this purpose. Although TMXDI contains an aromatic ring, its two isocyanate groups are not directly attached to the aromatic ring, making it less reactive than other aromatic diisocyanates, such as toluene diisocyanate (TDI) or methylene diphenyldiisocyanate (MDI-IUPAC name bis(4-isocyanatophenyl)methane). The experiments below illustrate properties of water-borne polyurethane binders made from an aliphatic diisocyanate and aromatic TMXDI with either poly(caprolactone) (PCL) or poly(propylene oxide) (PPO) as the other reactant. The experimental results demonstrate that the presence of both an aromatic diisocyanate and a polyether is necessary to achieve good DTD performance in an electrophoretic medium containing carbon black electrophoretic particles.

### EXAMPLE 1

### Synthesis of Polyurethanes

The reactants used in the experiments were as follows:

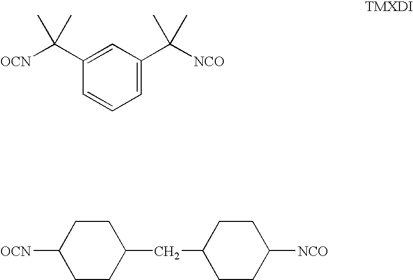

H₁₂MDI (IUPAC name bis(4-isocyanatocyclohexyl)methane)

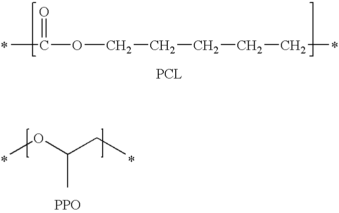

Five different polyurethanes were used in these experiments, as set out In Table 1 below:

TABLE 1

| Poly- | | | | | Solids, |
|---|---|---|---|---|---|
| urethane | Diisocyanate | Diol | M_{w} | pH | wt. % |
| A | H₁₂MDI | PPO | 64100 | 7.7 | 40 |
| B | TMXDI | PPO | 38700 | 8.4 | 40 |
| C | TMXDI | PCL | 29700 | 7.6 | 34 |
| D | TMXDI | PPO | 45000-55000 | 7.5-8.5 | 35 |
| E | H₁₂MDI | Polyester | 100-200K | 7.5-8.5 | 40 |

Polyurethanes A, B and C were formulated to have the same molar ratios of diol to diisocyanate; Polyurethane D is a custom polyurethane prepared by a third party in accordance with U.S. Patent Publication No. 2005/0124751, while Binder E was also a commercial polyurethane.

The synthesis of Polyurethane A was carried out under nitrogen as follows. A jacketed 500 mL glass reactor was equipped with a mechanical stirrer, a thermometer, and a nitrogen inlet. H₁₂MDI (20.99 g of Bayer Desmodur W, 0.08 mole), poly(propylene glycol) diol (50 g, supplied by Aldrich Chemical Company, Mₙ about 2000), and dibutyltin dilaurate (0.04 g, from Aldrich) were charged into the reactor and the mixture was heated at 90° C. for 2 hours. (Unless otherwise stated, in all the reactions below the reagents used are the same as those used in the synthesis of Polyurethane A.) A solution of 2,2-bis(hydroxymethyl)propionic acid (3.35 g, from Aldrich) in 1-methyl-2-pyrrolidinone (10 g, from Aldrich) was then added and the reaction allowed to proceed at 90° C. for another hour to produce an NCO-terminated prepolymer. The reactor temperature was then lowered to 70° C., and triethylamine (2.4 g, from Aldrich) was added; the resultant mixture was allowed to stand at this temperature for 30 minutes to neutralize carboxylic acid. The reactor temperature was then further lowered to 35° C. and de-ionized water (105 g) was added to convert the prepolymer to a water-borne polyurethane dispersion. Chain extension reaction was carried out immediately after the dispersion step with hexamethylenediamine (3.3 g, from Aldrich) dissolved in a small amount of de-ionized water over a period of 1 hour at 35° C. Finally, the dispersion was heated to 70° C. for 1 hour to ensure that all residual isocyanate groups had reacted.

The synthesis of Polyurethane B was carried out under nitrogen as follows. A prepolymer was prepared in a three-necked round-bottomed flask equipped with a magnetic stirrer, a condenser, and a nitrogen inlet. TMXDI (19.54 g, from Aldrich, 0.08 mole), poly(propylene glycol) diol (50 g), and dibutyltin dilaurate (0.04 g) were charged into the flask and the mixture was heated in a silicon oil bath on a hotplate at 90° C. for 2 hours. A solution of 2,2-bis(hydroxymethyl)propionic acid (3.35 g) in 1-methyl-2-pyrrolidinone (10 g) was then added and the reaction allowed to proceed at 90° C. for another hour to produce an NCO-terminated prepolymer. The reactor temperature was then lowered to 70° C., and triethylamine (2.4 g) was added; the resultant mixture was allowed to stand at this temperature for 30 minutes to neutralize carboxylic acid. At this point, dibutylamine (0.388 g, from Aldrich, 5 mole per cent relative to the residual NCO groups) was added as a chain stopper. The resultant reaction mixture was slowly added to de-ionized water (105 g) at 35° C. in a jacketed 500 mL glass reactor under mechanical stirring and a nitrogen atmosphere. Chain extension reaction was carried out immediately after the dispersion step with hexamethylenediamine (3.3 g) dissolved in a small amount of de-ionized water over a period of 1 hour at 35° C. Finally, the dispersion was heated to 70° C. for 1 hour to ensure that all residual isocyanate groups had reacted.

The synthesis of Polyurethane C was carried out under nitrogen as follows. A prepolymer was prepared in a three-necked round-bottomed flask equipped with a magnetic stirrer, a condenser, and a nitrogen inlet. TMXDI (19.54 g, 0.08 mole), polycaprolactone diol (31.25 g, from Aldrich, Mₙ about 1250), and dibutyltin dilaurate (0.04 g) were charged into the flask and the mixture was heated in a silicon oil bath on a hotplate at 80° C. for 2 hours. A solution of 2,2-bis(hydroxymethyl)propionic acid (3.35 g) in 1-methyl-2-pyrrolidinone (10 g) was then added and the reaction allowed to proceed at 80° C. for another hour to produce an NCO-terminated prepolymer. The reactor temperature was then lowered to 60° C., and triethylamine (2.4 g) was added; the resultant mixture was allowed to stand at this temperature for 30 minutes to neutralize carboxylic acid. The resultant reaction mixture was slowly added to de-ionized water (105 g) at 30° C. in a jacketed 500 mL glass reactor under mechanical stirring and a nitrogen atmosphere. Chain extension reaction was carried out immediately after the dispersion step with hexamethylenediamine (3.3 g) dissolved in a small amount of de-ionized water over a period of 1 hour at 30° C. Finally, the dispersion was heated to 70° C. for 1 hour to ensure that all residual isocyanate groups had reacted.

When water was added to TMXDI-based prepolymers, the formation of some large particles was observed. It was found that formation of such large particles could be avoided by adding the prepolymer to water, as described in the preparation of Polyurethanes B and C above. This problem did not occur with H₁₂MDI-based prepolymers.

### EXAMPLE 2

### Electro-Optic Properties

In order to evaluate the effect of the various polyurethane binders on the electro-optic properties of electrophoretic displays, electrophoretic capsules comprising an internal phase containing carbon black and titania electrophoretic particles in a hydrocarbon fluid, surrounded by a capsule wall formed from a gelatin/acacia coacervate, were prepared substantially as described in U.S. Patent Publication No. 2002/0180687, Paragraphs [0067] to [0072]. The resultant capsules were mixed with the binders and binder blends specified below and formed into experimental single pixel displays substantially as described in Paragraphs [0073] and [0074] of this Publication, except that a backplane comprising a carbon black electrode on a polymer film was used. The lamination adhesive used was Binder D doped with 180 parts per million of tetrabutylammonium hexafluorophosphate (cf. the aforementioned U.S. Pat. No. 7,012,735).

The resultant experimental displays were then tested for their dwell time dependence in both their black and white extreme optical states. The experimental displays could be driven between these two extreme optical states by 15 V, 500 millisecond pulses of appropriate polarity. Each display was first rapidly driven multiple times between its two extreme optical states to erase the effects of previous switching. To evaluate white state DTD, each display was then driven to its black extreme optical state, allowed to remain in this state for a period varying from zero to several minutes, and then switched to its white extreme optical state, and its reflectivity measured, and the measured reflectivity converted to standard L* units ((where L* has the usual CIE definition:
L*=116(R/R₀)^{1/3}−16,

where R is the reflectance and R₀ is a standard reflectance value). The white state DTD (“WS DTD”) given in Table 2 below is the maximum difference between the L* values of white extreme optical states caused by variation of the period for which the display had been allowed to remain in its black extreme optical state. Dark state DTD (“DS DTD”) was measured in a corresponding manner. The results obtained are shown in Table 2 below:

TABLE 2

| Binder | WS DTD L* | DS DTD L* |
|---|---|---|
| A | >6 L* | >4 L* |
| A/D (w/w = 3/1) | <2 L* | <2 L* |
| E | >4 L* | >4 L* |
| E/D (w/w = 3/1) | <2 L* | <2 L* |
| E/B (w/w = 3/1) | <2 L* | <2 L* |
| C | >8 L* | >4 L* |
| C/D (w/w = 3/1) | <2 L* | <2 L* |
| E/C (w/w = 3/1) | >6 L* | >4 L* |

From Table 2, it will be seen that Binder A, which is formed from PPO as its polyether, does not give good DTD performance when used alone as a binder; hence, the presence of PPO alone in a binder is not sufficient to achieve good DTD performance. However, when 25 weight per cent of Binder D was blended with Binder A, the DTD performance significantly improved. From a material point of view, this blending only introduces aromatic TMXDI moiety into the binder since the rest of the components in these two materials are exactly the same. This suggests that the use of an aromatic diisocyanate in the synthesis of the binder may be important in achieving good DTD characteristics. This view if reinforced by the fact that Binder E alone did not show good DTD performance. However, from Table 2 it will be seen that the DTD performance of Binder E improved when it is blended with either Binder B or D, both of which were produced from the aromatic diisocyanate TMXDI and the polyether diol PPO. Thus, the results in Table 2 strongly suggest that to achieve good DTD performance with the carbon black/titania electrophoretic medium used, it is necessary to use a polyurethane binder containing an aromatic diisocyanate.

It is still necessary to decide whether the presence of an aromatic diisocyanate alone is sufficient for good DTD performance or whether such good performance requires both an aromatic diisocyanate and a polyether diol, and Binder C, which combines an aromatic diisocyanate with polycaprolactone, was synthesized to aid in resolving this question. From Table 2, it will be seen that Binder C alone did not give good DTD performance, whereas a blend of Binder C with Binder D did give good DTD performance. This strongly suggests that the presence of both an aromatic diisocyanate and a polyether diol is required for good DTD performance. The correctness of this deduction is confirmed by the fact that a blend of Binders C and E (both of which use a polyester diol) does not give good DTD performance. It should be noted that the improved DTD performance exhibited by a polyurethane formed from an aromatic diisocyanate and a polyether diol cannot be attributed simply to a change in the volume resistivity of the polyurethane, since all the binders used in the experiments described above had volume resistivities of the same order of magnitude.

### EXAMPLE 3

### Effect of Binder Composition on DTD

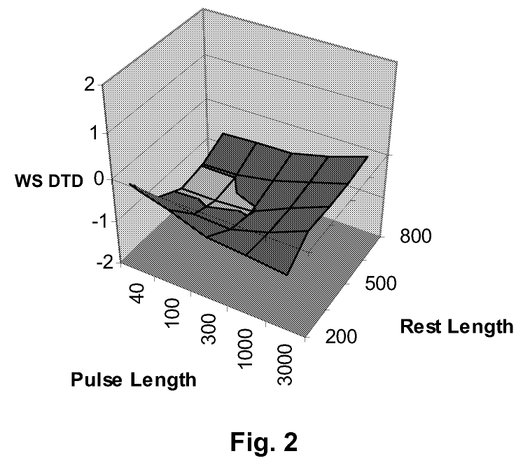

The experiments used to generate the graph shown in FIG. 1 were repeated with the same capsules but using as the binder Polyurethane D from Table 1 above. The results are shown in FIG. 2.

FIG. 2 shows substantial reduction in DTD compared with FIG. 1; the overall Max-Min range is reduced from 2.4 L* to 1.2 L*, and the sign of the DTD is generally opposite to that in FIG. 1, thus implying that the electrophoretic particles were experiencing a smaller voltage than that actually applied between the electrodes.

The experiments which produced the graphs of FIGS. 1 and 2 were repeated several times using the same binders but different types of capsules. Although the values of the DTD range varied considerably with the specific type of capsules used (varying from 3.4 to 7.2 L* units for the FIG. 1 binder and from 0.6 to 4.7 L* for Polyurethane D), in every case the Polyurethane D binder showed a lower DTD range than the FIG. 1 binder.

### EXAMPLE 4

### Effect of Mixed Binders on DTD

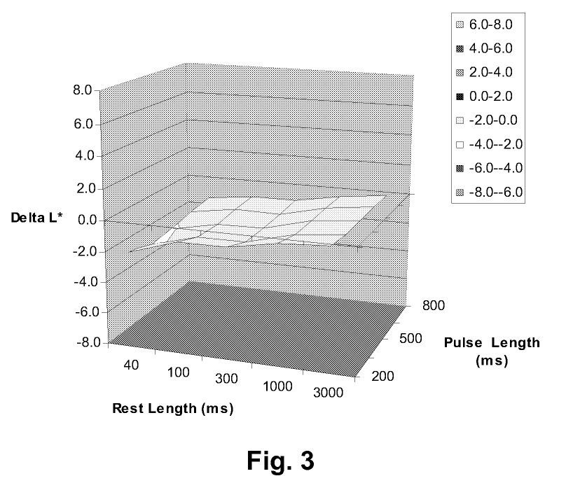

As noted above, the FIG. 1 binder and the Polyurethane D binder typically result in DTD values of opposite sign for a given capsule, rest period and pulse length. Accordingly experiments were conducted to determine whether use of a blend of the two binders would give better results than either binder alone. Accordingly, the experiments of Example 3 were repeated using the same capsules as in Example 3 for the two binders and for a 1:3 w/w mixture of the Polyurethane D binder and the prior art binder. It should be noted that both the Polyurethane D binder and the 1:3 mixture are binders of the present invention. The results, taken at 25° C. and 30 per cent relative humidity, are shown in FIGS. 3 to 8 of the accompanying drawings, where these Figures are as follows:

FIG. 3: White state DTD, Polyurethane D binder;

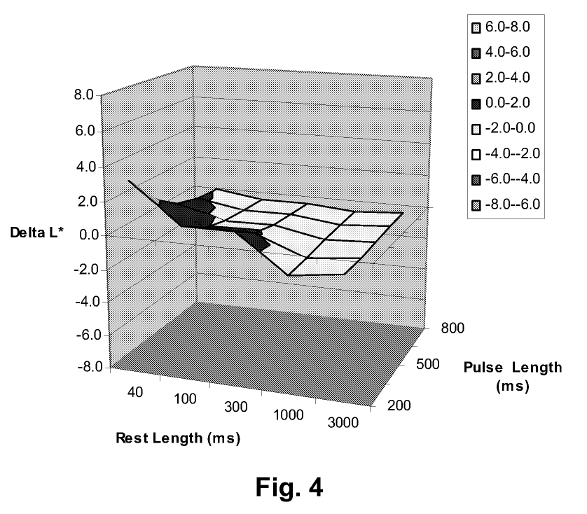

FIG. 4: White state DTD, FIG. 1 binder;

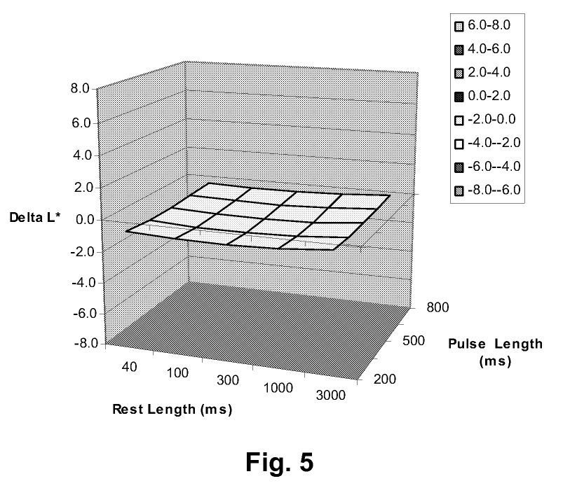

FIG. 5: White state DTD, Mixture;

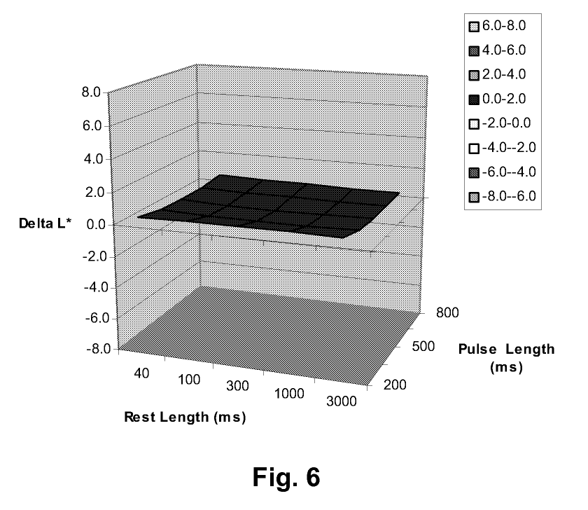

FIG. 6: Dark state DTD, Polyurethane D binder;

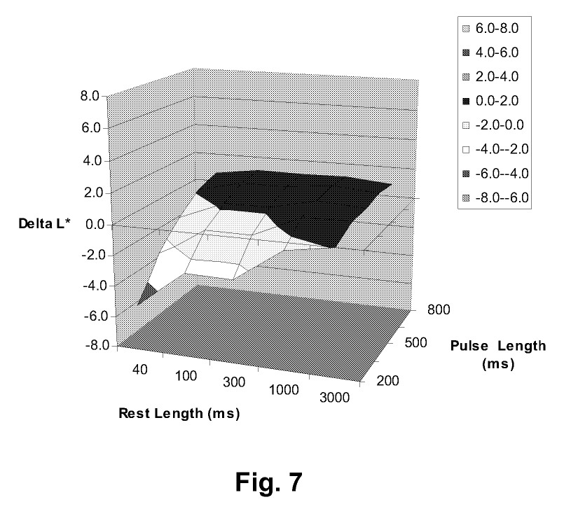

FIG. 7: Dark state DTD, FIG. 1 binder; and

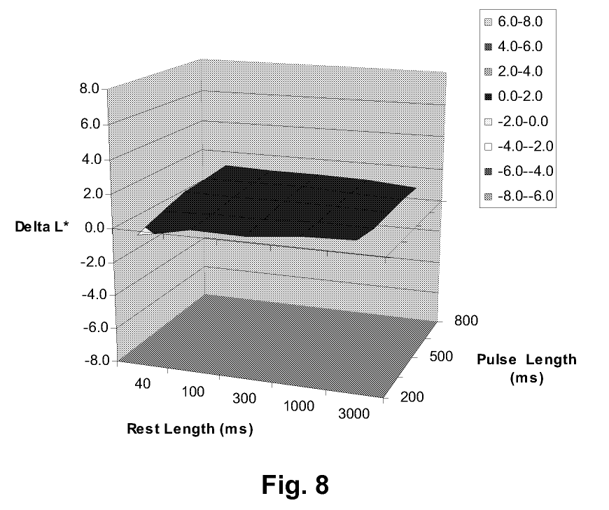

FIG. 8: Dark state DTD, Mixture;

From FIGS. 3 to 8 it will be seen that the blend showed reduced DTD in the white state and substantially the same DTD as Polyurethane D in the dark state; in both states, the blend was much superior to the FIG. 1 binder. The actual values were as follows:

FIG. 3: Range 3.3 L*;

FIG. 4: Range 4.4 L*, standard deviation 0.4 L*;

FIG. 5: Range 0.6 L*, standard deviation 0.0 L*;

FIG. 6: Range 1.1 L*, standard deviation 0.3 L*;

FIG. 7: Range 6.3 L*, standard deviation 0.3 L*; and

FIG. 8: Range 1. 3 L*, standard deviation 0.1 L*.

The foregoing experiments show that the presence of aromatic diisocyanate residues (such as TMXDI residues) along with polyether diol residues (for example PPO residues) in a polyurethane binder offers a beneficial reduction in dwell time dependency in encapsulated electrophoretic displays containing carbon black electrophoretic particles. A low DTD is highly desirable in electrophoretic displays to permit accurate and consistent rendition of gray scale images despite arbitrary differences in the times between changes in displayed images.

Numerous changes and modifications can be made in the preferred embodiments of the present invention already described without departing from the scope of the invention. Accordingly, the foregoing description is to be construed in an illustrative and not in a limitative sense.

1. An electrophoretic medium comprising a plurality of discrete droplets of an electrophoretic internal phase, the internal phase comprising a fluid and carbon black particles in the fluid, the droplets being surrounded by a polyurethane binder formed by a diisocyanate and a polyether diol, wherein at least about 20 mole per cent of the diisocyanate is an aromatic diisocyanate.

2. An electrophoretic medium according to claim 1 wherein at least about 50 mole per cent of the diisocyanate is an aromatic diisocyanate.

3. An electrophoretic medium according to claim 2 wherein at least about 75 mole per cent of the diisocyanate is an aromatic diisocyanate.

4. An electrophoretic medium according to claim 1 wherein the internal phase comprises carbon black particles in a colored fluid.

5. An electrophoretic medium according to claim 1 wherein the internal phase comprises carbon black particles and a second type of electrophoretic particles differing from the carbon black particles in at least one optical characteristic and in electrophoretic mobility.

6. An electrophoretic medium according to claim 5 wherein the second type of electrophoretic particles comprise titania particles bearing a charge of opposite polarity to that on the carbon black particles.

7. An electrophoretic medium according to claim 1 wherein the polyurethane binder consists of a single polyurethane formed from an aromatic diisocyanate and a polyether diol.

8. An electrophoretic medium according to claim 1 wherein the polyurethane binder comprises a blend of at least two polyurethanes, at least one of which is formed from an aromatic diisocyanate and a polyether diol.

9. An electrophoretic medium according to claim 8 wherein the polyurethane binder comprises a first polyurethane formed from an aromatic diisocyanate and a polyether diol, and a second polyurethane formed from an aliphatic diisocyanate and a polyester diol.

10. An electrophoretic medium according to claim 9 wherein the polyether diol comprises poly(propylene glycol).

11. An electrophoretic medium according to claim 10 wherein the poly(propylene glycol) has a molecular weight of about 1500 to about 5000.

12. An electrophoretic medium according to claim 1 which is an encapsulated electrophoretic medium having a capsule wall interposed between each droplet and the binder.

13. An electrophoretic medium according to claim 1 which is of the polymer-dispersed type with the droplets of internal phase dispersed directly in a continuous phase of the binder.

14. An electrophoretic medium according to claim 1 which is of the microcell type, with the binder forming the walls of a plurality of closed cavities within which the internal phase is retained.

15. An electrophoretic medium according to claim 1 wherein the aromatic diisocyanate comprises TMXDI.

16. An electrophoretic display comprising an electrophoretic medium according to claim 1 in combination with at least one electrode disposed adjacent the electrophoretic medium and arranged to apply an electric field thereto.

17. An electrophoretic medium comprising a plurality of discrete droplets of an electrophoretic internal phase, the internal phase comprising a fluid and carbon black particles in the fluid, the droplets being surrounded by a polyurethane binder formed by a diisocyanate and a polyether diol, wherein at least about 20 mole per cent of the diisocyanate comprises TMXDI.

18. An electrophoretic medium according to claim 17 wherein at least about 50 mole per cent of the diisocyanate comprises TMXDI.

19. An electrophoretic medium according to claim 17 wherein the diisocyanate consists essentially of TMXDI.

20. An electrophoretic display comprising an electrophoretic medium according to claim 17 in combination with at least one electrode disposed adjacent the electrophoretic medium and arranged to apply an electric field thereto.
